(19) United States
(12) Patent Application Publication
(10) Pub. No.: US 2025/0339830 A1
(43) Pub. Date: Nov. 6, 2025

(54) OXYGEN-BASED CONTROL OF POLYMERIZATION REACTIONS

(71) Applicants: YOKOGAWA FLUENCE ANALYTICS, INC, Stafford, TX (US); THE ADMINISTATORS OF THE TULANE EDUCATIONAL FUND, NEW ORLEANS, LA (US)

(72) Inventors: WAYNE F. REED, New Orleans, LA (US); JULIA SIQUEIRA, New Orleans, LA (US)

(73) Assignees: YOKOGAWA FLUENCE ANALYTICS, INC, STAFFORD, TX (US); THE ADMINISTRATORS OF THE TULANE EDUCATIONAL FUND, New Orleans, LA (US)

(21) Appl. No.: 18/812,818

(22) PCT Filed: Feb. 26, 2023
(86) PCT No.: PCT/US2023/062997

§ 371 Date: Aug. 22, 2024

Related U.S. Application Data
(60) Provisional application No. 63/268,602, filed on Feb. 26, 2022.

(51) Int. Cl. B01J 19/00

(52) U.S. Cl. CPC B01J 19/0033; B01J 2219/00164; B01J 2219/00168; B01J 2219/002; B01J 2219/00218; B01J 2219/00243

(57) ABSTRACT

Methods and devices for controlling polymerization reactions using the controlled addition of oxygen to a reactor. The method may include providing a reactor comprising one or more chemical components suitable for facilitating a polymerization reaction and continuously measuring one or more polymer characteristics of polymers generated by the polymerization reaction in the reactor. The method may also include determining, using a control algorithm, based on the continuous measurements of one or more polymer characteristics, the amount of oxygen to add to the reactor at one or more time points during the polymerization reaction in order to cause the one or more polymer characteristics to follow a predetermined target trajectory.

### CROSS-REFERENCE TO RELATED PATENT APPLICATIONS

This patent application is a national phase of the PCT application PCT/US2023/062997, entitled “OXYGEN-BASED CONTROL OF POLYMERIZATION REACTIONS,” filed Feb. 26, 2023, which claims the benefit under 35 U.S.C. § 119(e) of U.S. Patent Application Ser. No. 63/268,602, entitled “OXYGEN-BASED CONTROL OF POLYMERIZATION REACTIONS,” filed on Feb. 26, 2022, each of the foregoing application is incorporated herein by reference in its entirety.

### FIELD

The present disclosure is broadly concerned with methods for controlling polymerization reactions. In particular, the present disclosure is related to the control of polymerization reactions using the controlled addition of oxygen. In some non-limiting instances, the presently disclosed methods may include methods for controlling molecular weight and associated properties of polymers and/or the composition of copolymers generated during polymerization reactions through the controlled addition of oxygen.

### BACKGROUND

Many properties of polymeric materials, such as tensile strength and processability, are due to the molecular weight of constituent polymer molecules. Controlling polymer molecular weight is hence a capability for determining polymer product characteristics. Similarly, copolymerization allows two or more comonomers of different properties to join together to produce new material properties. An example is the copolymerization of polybutadiene and styrene to produce non-brittle high-impact polystyrene. Pairs or groups of comonomers can be copolymerized to give many favorable features to polymeric products. When two incompatible monomer types are copolymerized, self-organizing structures can form, both in bulk material and on surfaces.

There are several ways that the molecular weight of polymers can be controlled during polymerization. These include varying temperatures, initiator, catalyst, and use of transfer agents. In semi-batch operation, monomer feed to the reactor can be used to control molecular weight and also copolymer composition. However, additional methods for the control of polymerization reactions are desirable.

### BRIEF SUMMARY

In one aspect, a device controlling a polymerization reaction by varying oxygen may include a reactor in which a polymerization reaction takes place therein. The device may also include a means of controlled delivery of oxygen to the reactor. The device may also include a means of continuously measuring one or more polymer characteristics of polymers generated by the polymerization reaction in the reactor.

In another aspect, a method is provided for controlling a polymerization reaction by varying oxygen. The method may include providing a reactor comprising one or more chemical components suitable for facilitating a polymerization reaction. The method may also include continuously measuring one or more polymer characteristics of polymers generated by the polymerization reaction in the reactor. The method may also include determining, using a control algorithm, based on the continuously measured one or more polymer characteristics, an amount of oxygen to add to the reactor at one or more time points during the polymerization reaction to cause the one or more polymer characteristics to follow a predetermined target trajectory.

Additional embodiments and features are set forth in part in the description that follows and will become apparent to those skilled in the art upon examination of the specification or may be learned by the practice of the disclosed subject matter. A further understanding of the nature and advantages of the disclosure may be realized by reference to the remaining portions of the specification and the drawings, which form a part of this disclosure.

### BRIEF DESCRIPTION OF THE DRAWINGS

In order to describe the manner in which the advantages and features of the disclosure can be obtained, reference is made to embodiments thereof which are illustrated in the appended drawings. Understanding that these drawings depict exemplary embodiments of the disclosure and are not therefore to be considered to be limiting of its scope, the principles herein are described and explained with additional specificity and detail through the use of the accompanying drawings in which:

FIG. 1A depicts a system diagram for controlling polymerization reactions using a controlled addition of oxygen according to an exemplary embodiment of the present disclosure;

FIG. 1B depicts a process flow diagram for controlling polymerization reactions using a controlled addition of oxygen according to an exemplary embodiment of the present disclosure;

FIG. 2 depicts raw light scattering and ultra-violet absorption data versus time in a reactor for two acrylamide (Am) free radical reactions, according to an exemplary embodiment of the present disclosure;

FIG. 3 depicts data showing the concentration of dissolved O₂ (DO) in the reactor versus time, measured by a DO probe inside the reactor, according to an exemplary embodiment of the present disclosure;

FIG. 4 depicts data showing the contrast in the short and long conversion plateaus between the two airflow rates of 192 standard cubic centimeters per minute (sccm) and 15 sccm, shown in FIGS. 2 and 3, according to an exemplary embodiment of the present disclosure;

FIG. 5 depicts data showing the concentration of polyacrylamide (pAm) versus reaction time, obtained from the concentration of Am or [Am] via mass balance, for a reaction with no O₂ and a second one with 6 sccm, according to an exemplary embodiment of the present disclosure;

FIG. 6 depicts data comparing cumulative weight average molecular weight M_{w} for the two reactions in FIG. 5, according to an exemplary embodiment of the present disclosure;

FIG. 7 depicts data showing the instantaneous weight average molecular weight M_{w,inst} versus the concentration of pAm, for the data depicted in FIG. 6 computed according to Equation 4, according to an exemplary embodiment of the present disclosure;

FIG. 8 depicts data showing the cumulative reduced viscosity (RV) obtained from the highly dilute sample stream versus the concentration of pAm or [pAm], according to an exemplary embodiment of the present disclosure;

FIG. 9 depicts data showing RVᵢₙₛₜ versus the concentration of pAm, computed by Equation 4, substituting RV for M_{w}, according to an exemplary embodiment of the present disclosure;

FIG. 10 depicts a calibration curve showing how M_{w,inst} changes with flow rate Q as a function of Am concentration in the reactor, according to an exemplary embodiment of the present disclosure;

FIG. 11 depicts data showing M_{w} versus the concentration of polystyrene sulfonate (pSS) or [pSS] and the use of O₂ to shorten pSS chains via chain termination and how O₂ flow below O₂ threshold level [O₂]ₜ leads to successful chain termination shortening of styrene sulfonate (SS) free radical polymerization in water at 100 mM NaCl ionic strength, according to an exemplary embodiment of the present disclosure; and

FIG. 12 is a flow chart illustrating the steps for controlling a polymerization reaction using the addition of oxygen according to an exemplary embodiment of the present disclosure.

### DETAILED DESCRIPTION

The present disclosure provides methods for controlling polymerization reactions that include the use of low, controlled levels of oxygen (O₂) as a reversible means of actively controlling molecular weight. The composition of copolymers can also be controlled with O₂.

Molecular weight depends on several factors, including temperature, the type and concentration of initiator, the concentration of monomer, and the type of polymerization mechanism; e.g. free radical, controlled free radical, or step-growth reactions such as polycondensation. Chain transfer agents (CTA), such as sodium formate for polyacrylamide molecular weight control, shorten kinetic chain lengths according to the basic free radical expression for instantaneous weight average kinetic chain length X_{w,inst} (weight average number of monomers in a polymer chain)

$${X}_{w , inst} = d \frac{{k}_{p}}{{k}_{t} [ R ] Y + {k}_{3} [ CTA ]} [ M ] \qquad ( Equation 1 )$$

where the weight average is used because light scattering yields the cumulative weight average molecular weight M_{w}, whence instantaneous molecular weight M_{w,inst} is computed. In Equation 1, kₚ, kₜ, and k₃ are the propagation, termination, and chain transfer rate constants, respectively, and [M], [R], and [CTA] are molar concentrations of monomer, free radical, and chain transfer agent, respectively. Y is a dimensionless constant that varies from 1 for recombination to 2 for pure disproportionation, with a value between 1 and 2 when both processes occur. The dimensionless constant d is the instantaneous polydispersity index M_{w}/Mn, usually around 2 for free radical polymerization. As [CTA] increases the chain length X_{w,inst} decreases. When the CTA is an added chemical [CTA] remains approximately constant in the denominator, and the chain shortening effect is irreversible. M_{w,inst} is related to X_{w,inst} simply by multiplying it by the monomer molecular weight m (g/mol); M_{w,inst}=mX_{w,inst}. For acrylamide m=71.08 g/mol.

If [CTA] can be controlled in Equation 1, then X_{w,inst} can be driven down by increasing [CTA] and increased by decreasing [CTA]. The present disclosure posits molecular oxygen, O₂, as a highly flexible CTA whose value in the denominator, [CTA], can be modulated at will. While it is generally known that O₂ inhibits the reaction, its practical use has generally been limited to adding bursts of air or O₂ to slow or stop runaway exothermic reactions. A low O₂ concentration threshold, [O₂]ₜ, for stopping a reaction means that a small amount of O₂ is used to stop a free radical reaction.

Presumably, one reason that O₂ has not been previously used as a CTA is that the concentration of O₂ that stops a free radical reaction completely is low, on the order of 0.1 mg/L, whereas saturation of dissolved O₂ at T=25° is about 6.56 mg/L. This means this narrow O₂ concentration window below [O₂]ₜ can be used for molecular weight control purposes and may use as a means of fine control of low gas flow rates. Furthermore, continuous monitoring of molecular weight, monomer concentrations, conversion, reduced viscosity, composition (in the case of copolymers), and other properties may be used to both observe the chain termination effects and control molecular weight and associated properties of polymers and/or the composition of copolymers generated during polymerization reactions through controlled addition of oxygen.

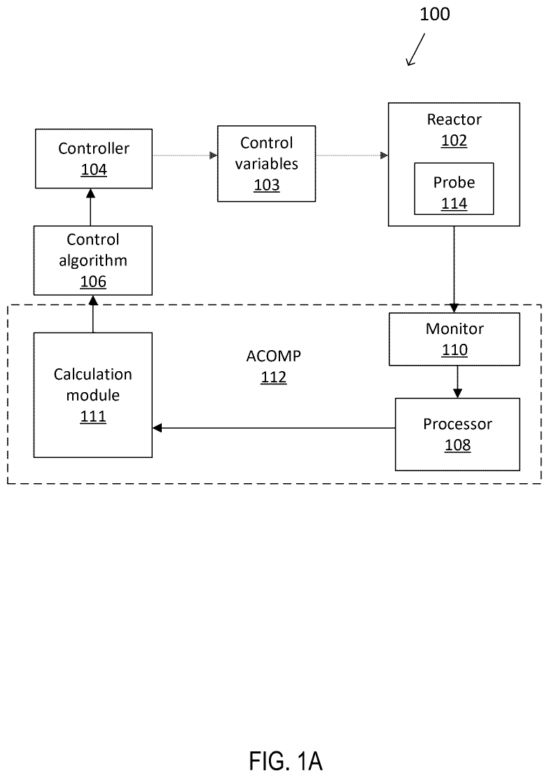

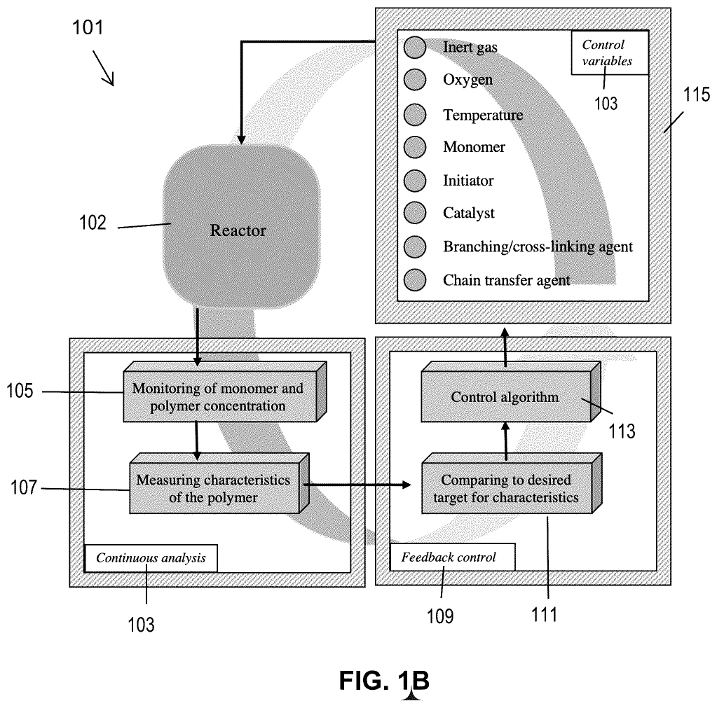

FIG. 1A depicts a system diagram for controlling polymerization reactions using a controlled addition of oxygen according to an exemplary embodiment of the present disclosure. System 100 includes reactor 102 where a polymerization reaction takes place to generate a polymer. The reactor 102 may optionally include a submerged oxygen sensor or probe 114 for continuously monitoring the concentration of oxygen. Optionally, probe 114 for dissolved O₂ can be situated in reactor 102, like the one used for some of the data presented here.

In some variations, the oxygen may be delivered to the reactor in form of a gas.

System 100 also includes a controller 104 for controlling process variables 103, such as inert gas, oxygen concentration, temperature, monomer, initiator, catalyst, branching or cross-linking agent, chain transfer agent, and/or chain termination agent, among others. Controller 104 includes a means of varying one or more additional control variables to the reactor.

In some variations, the one or more additional control variables are selected from the group consisting of temperature, additions to the reaction of monomers, comonomers, initiator, catalyst, branching/cross-linking agents, and chain transfer agents.

Controller 104 provides the means of controlled delivery of oxygen to reactor 102. Controller 104 is equipped with a means of fine, low flow rate control of O₂ entry into reactor 102, and a means of purging O₂ from reactor 102 by a flow of inert gas (e.g., nitrogen or argon). Controller 104 is operable to automatically deliver the amount of oxygen to the reactor determined by a control algorithm 106.

System 100 also includes the control algorithm 106 for controlling the process variables 103 via controller 104. The control algorithm 106 is stored in a storage device or a tangible, non-transitory, computer-readable media. Instructions, when executed by the processor 108, are operable to determine using the control algorithm 106, based on the continuous measurements of one or more polymer characteristics, an amount of oxygen to add to the reactor at one or more time points during the polymerization reaction to cause the one or more polymer characteristics to follow a predetermined target trajectory.

System 100 also includes Automatic Continuous Online Monitoring of Polymerization reaction (ACOMP) system 112 produces measured polymer characteristics. The ACOMP system 112 is an efficient means for such monitoring and enables one embodiment of the disclosure.

The ACOMP system 112 includes monitors 110 that can monitor monomer and polymer concentration, among others. For example, monitors 110 provide a means of continuously monitoring the concentration of monomers and polymers in the reactor. Monitors 110 provide a means of continuously monitoring viscosity, such as capillary-type viscometers. Monitors 110 also provide a means of continuously monitoring cumulative weight average molecular weight M_{w}, among others. For example, monitors 100 may include a light scattering device that yields the cumulative weight average molecular weight M_{w}, while the instantaneous molecular weight M_{w,inst} is computed by the ACOMP system 112 based on Equation 1.

The ACOMP system 112 also includes a processor 108 which can receive and process the data collected from the monitors 110. For example, processor 108 is configured to receive the data from the means of continuously monitoring the concentration of monomers and polymers in the reactor.

The ACOMP system 112 also includes a calculation module 111 that calculates one or more polymer characteristics based on the data received by processor 108 and generates the control algorithm 106 based on comparing the measured polymer characteristics to a predetermined target for one or more polymer characteristics using the processor 108.

The control algorithm 106 may direct which control variables 103 can be manually controlled by an operator and allows for computationally assisted active control. The control variables 103 may be controlled automatically via controller 104, which is a computationally based controller and allows for automatic active control.

The ACOMP system 112 may include a tangible, non-transitory, computer-readable media having instructions encoded. The instructions, when executed by processor 108, are operable to determine using the control algorithm 106, based on the continuous measurements of one or more polymer characteristics, the amount of oxygen to add to the reactor to stop the polymerization reaction or to reduce a reaction rate.

As used herein, the term “polymer reaction,” in all of its forms refers to any type of chemical or physical reaction which involves polymers. This includes, but is not limited to, covalently producing polymers from monomers or comonomers, causing branching or cross-linking reactions, causing breakage of polymer bonds to produce smaller polymers, causing the formation of block copolymers, causing the formation of a star, comb, dendritic, or other highly specific polymer architectures, any type of reaction causing a chemical modification of polymers, such as but not limited to, imbuing a polymer with negative and/or positive electrical charge, imbuing a polymer with acid or base properties, linking polymers, or growing polymers from nano- or microparticles such as silica, metals such as silver or gold, gels, metal oxides such as titanium dioxides, clay, etc., and causing reversible or irreversible supramolecular assemblage of polymers and other particles.

In terms of reactions producing polymers from monomers, any type of polymerization mechanism can be used. Hence, chain growth and step growth reactions are included. The former is free radical and controlled radical polymerization. Under controlled radical polymerization are found methods such as, but not limited to, ring-opening metathesis polymerization (ROMP), atom transfer radical polymerization (ATRP), reversible addition-fragmentation chain transfer polymerization (RAFT), and nitroxide mediated polymerization (NMP). Polymer reactions can occur in solution, bulk, and heterogeneous phases such as micelles, emulsions, inverse emulsions, and dispersions. Metallocene-based chain growth is included, such as is used in polyolefins. Step growth includes polycondensation reactions such as those used in the production of polypeptides, polynucleotides, polyimides, polyamides, and polyurethanes. As used herein, the term “inert gas,” in all of its forms, refers to gases such as Nitrogen (N₂) and other non-reactive gases, including but not limited to, the Group 8A inert gases of the periodic table: Argon, Helium, Krypton, Neon, Xenon, and Radon.

The present disclosure places no limitations on the types of polymer reactors, also referred to as polymer reaction vessels, to which it applies. Polymer reactors can be as small as milliliters or less and as large as tens or hundreds of thousands of liters. Polymer reactors can be made of many different materials, including, but not limited to, metals such as stainless steel or aluminum, glass, porcelain, and ceramics. The polymer reactors can be of a batch type, the type where reagents can be fed in, sometimes termed semi-batch, or continuous. If continuous reactors are used, then the approach will be different according to the type of continuous reactor. In long tubular continuous reactors, for example, different actively controlled process stages can occur at different points along the trajectory of reacting fluids through the reactor. In continuously stirred tank reactors a steady state is reached in the reactor and multiple continuous stirred-tank reactors (CSTR) can be placed in serial flow to reach different stages in the actively controlled multi-stage process.

To achieve the conditions for active control of polymer molecular weight (MW) it is useful to monitor the molecular weight, to be controlled, and associated quantities, such as monomer and polymer composition, and to monitor these characteristics with sufficient frequency to allow for the active control of polymer molecular weight. In the case where the composition is to be controlled, it is useful to be able to distinguish and monitor the course of the conversion of the comonomers involved. Sufficiently frequent measurements can be made in some instances by monitors 110 including in-reactor spectroscopic probes, such as Raman scattering and infrared (IR). Within the ACOMP system 112, distinguishing of comonomer has been accomplished with refractive index, ultra-violet absorption, near IR, IR, and conductivity. Where chiral molecules are mixed with achiral molecules, the former can be distinguished with a polarimeter or other sensor of optical activity, such as circular dichroism or circular birefringence. Monitors 110 including nuclear magnetic resonance (NMR) can also be used in ACOMP system 112 for distinguishing comonomers. The ACOMP system is also referred to as the ACOMP platform.

The measurement of molecular weight using ACOMP system 112 involves total intensity light scattering, multi-angle when used, together with polymer concentration determination. Intrinsic viscosity (IV) is also related to molecular weight and a capillary-type viscometer is frequently used in the ACOMP detector train. The intrinsic viscosity combined with molecular weight can be used to assess branching. Simultaneous low and high shear viscosity measurements in ACOMP system 112 can also be used to assess branching via shear non-Newtonian shear behavior.

To carry out active control of molecular weight, information on the reaction characteristics can be used with sufficient frequency to allow control actions to be taken in time intervals that are short compared to the time of the reaction. As used herein, the term “sufficient frequency,” in all of its forms, refers to the frequency of data acquisition such that control of the desired reaction characteristics is carried out in a time much less than the time on which a substantial deviation of the controlled characteristics can occur. Substantial deviation depends on the degree to which control is desired. For example, not limiting, in some cases controlling the desired characteristics to within 35% of the model trajectory may be acceptable, whereas in other cases, control to within 10%, 5%, or even less than 1% deviation may be used. Sufficient frequency of reaction characteristic information is frequent enough to control the characteristic within the desired bounds of deviation from the model trajectory.

According to a non-limiting example of the present disclosure, the ACOMP system 112 makes measurements of multiple reaction characteristics, such as M_{w}, reduced viscosity, conversion, monomer and polymer concentrations, and comonomer composition once per second. Faster and slower rates may give a general sense of frequency in reactions that typically last tens of minutes or a few hours. When the period of data measurements (the inverse of the frequency) is well within the time scale to control deviations such measurements are often termed continuous, as in the term Automatic Continuous Online Monitoring of Polymerization reactions (ACOMP). Manual sampling methods, such as those methods that are widely employed both in the polymer manufacturing industry and research laboratories, seldom have a high enough frequency for active control. Similarly, online chromatographic methods generally do not have sufficient frequency either, although they could be employed in the present application.

The active control of one or more reaction variables during a reaction stage can be accomplished by one of three means according to the present disclosure. In manual active control a human has access to the data of the relevant characteristics of sufficient frequency, on which said human follows a reaction trajectory for one or more relevant characteristics by manually controlling one or more process control variables, such as described in the section “Means of control”. The control algorithm 106 to direct which control variables can be manually controlled by the operator allows for computationally assisted active control. Finally, the process control variables are controlled automatically via the computationally based controller 103, which allows for automatic active control.

As used herein, the term “reaction trajectory,” in all of its forms, refers to the specific mathematical form of a reaction characteristic, such as molecular weight (MW) or composition, versus a dependent variable. The common dependent variables in polymerization reactions are time and polymer or monomer concentration. The reaction trajectory can determine the final characteristics of the polymer, including its molecular weight and composition distributions. In the case of copolymers, the instantaneous composition trajectory can determine its final composition distribution. Hence, the characteristics of the final polymer are controlled by controlling the reaction trajectories.

Now, a specific reaction characteristic is considered, such as but not limited to, the cumulative weight average molecular weight (M_{w}), which can be measured frequently or continuously during polymer synthesis by a method such as using ACOMP system 112. Consider a general characteristic X. The online monitoring of reactor contents yields the cumulative value of X in the reactor, X_{c}. The buildup of X and its resulting distribution depends on the instantaneous value of X, i.e., Xᵢₙₛₜ, and how much polymer concentration of Xᵢₙₛₜ is added to the accumulating population. Concretely, the relationship between X_{c} and Xᵢₙₛₜ is, by definition, given by Equation (2) as follows:

$${X}_{c} ( {C}_{p} ) = \frac{{\int }_{0}^{{C}_{p}} {X}_{inst} ( {C}_{p}^{′} ) {dC}_{p}^{′}}{{C}_{p}} \qquad ( Equation 2 )$$

where Cₚ is polymer concentration. Xᵢₙₛₜ(Cₚ) can be determined from Equation 1 by the measured cumulative value X_{c}(Cₚ) and Cₚ via Equation 3 as follows:

$${X}_{inst} ( {C}_{p} ) = \frac{d [ {C}_{p} {X}_{c} ( {C}_{p} ) ]}{{dC}_{p}} . \qquad ( Equation 3 )$$

M_{w}(Cₚ) can be measured directly from light scattering and concentration detectors in the ACOMP system. M_{w,inst}(Cₚ) can be computed from the ACOMP value of M_{w}(Cₚ) according to Equation 2 by

$${M}_{w , inst} ( {C}_{p} ) = \frac{d ⌊ {C}_{p} {M}_{w} ( {C}_{p} ) ⌋}{{dC}_{p}} . \qquad ( Equation 4 )$$

Computation of M_{w,inst} from the primary ACOMP values of M_{w} and Cₚ allows the instantaneous weight average of the molecular weight distribution (MWD) to be followed, and a histogram representation of the MWD to be made as synthesis proceeds. Up to here, all quantities are model-independent and based on primary detector measurements.

Similarly, the instantaneous composition of comonomer j in a copolymer with N different copolymers, F_{inst,j}, is given by

$${F}_{inst , j} ( t ) = \frac{{dC}_{j} / dt}{d ( {\sum }_{i = 1}^{N} {C}_{j} ) / dt} = \frac{{dC}_{j}}{d ( {\sum }_{i = 1}^{N} {C}_{j} )} . \qquad ( Equation 5 )$$

F_{inst,j} can be computed from the concentrations of the individual comonomers, where dC_{p,j}=−dC_{m,j}; i.e. the loss of monomer dC_{m,j}, which is negative, shows up as an increase of C_{m,j} in polymeric form.

The presently disclosed apparatus, methods, and systems include a reactor 102 where the polymerization reaction takes place, a means for continuous analysis, a means for control of the desired control variables, and a means for delivering these control variables into the reactor. The means of controlled delivery of oxygen to the reactor may include controller 104 operable to automatically deliver the amount of oxygen to reactor 102 determined by the control algorithm 106.

FIG. 1B depicts a non-limiting process flow diagram for controlling polymerization reactions using a controlled addition of oxygen, according to an exemplary embodiment of the present disclosure. As illustrated in FIG. 1B, process 101 also includes continuous analysis 103, which includes monitoring monomer and polymer concentration by using monitors 110 at step 105. The monitors 110 may also monitor other reaction characteristics, such as viscosity, among others. Continuous analysis 103 also includes calculating polymer characteristics (e.g., M_{w,inst}, F_{inst,j}) by using ACOMP system 112 at step 107.

Process 101 also includes feedback control 109, which includes comparing calculated polymer characteristics to desired targets for polymer characteristics by using the processor 108 at step 111 and generating a control algorithm at step 113.

Process 101 also includes varying the control variables 103 to the reactor 102 at step 115. The control variables 103 include one or more temperatures, and additions to the reaction of monomers, comonomers, initiators, catalysts, branching/cross-linking agents, chain transfer agents, and/or chain termination and shortening agents, among others. Process 101 also includes a polymer reaction in reactor 102 to generate a desired polymer.

For the results presented below, reactor 102 contained approximately 500 cubic centimeters (ccs) of the aqueous reaction medium and about 100 ccs of headspace. Continuous reaction monitoring data were taken using the ACOMP system 112, which is a Fluence Analytics Inc 3^{rd} generation ACOMP instrument. An Aalborg gas flow controller (GFC) with a flow rate range from 0 to 10 sccm was used for introducing O₂ into reactor 102, from a compressed air tank Ultra Zero grade (about 20% O₂). For the N₂ purge and higher compressed air flows (above 75 sccm), an MKS G-series mass flow controller (MFC) was employed, with the same O₂ source. In some variations, dissolved O₂ content in mg/L may also be measured—for the reactions carried out at low temperatures—through an in situ rugged dissolved oxygen (RDO) probe and Thermo-Fischer Orion Star A216 meter. This may provide additional quantitative data from inside the reaction medium and qualitative data when used to monitor the headspace. The reactor content, at 3% or 3.4% solids, was diluted in the ACOMP system 112 to concentrations ranging from 0.4 mg/ml to 1.5 mg/ml in the detector train, through two separate dilution stages.

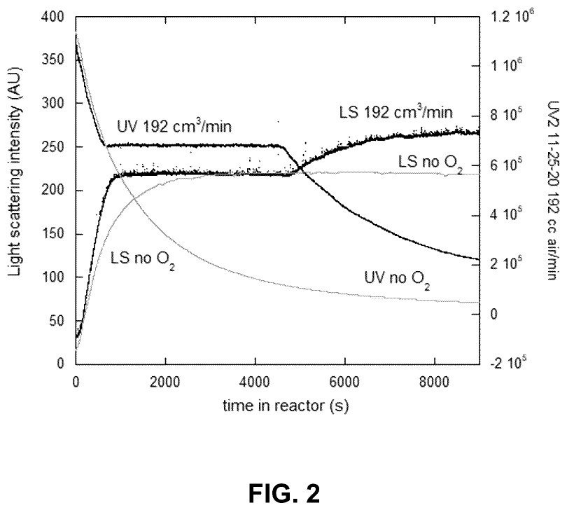

FIGS. 2-10 depict data for acrylamide (Am) free radical polymerization reactions initiated by potassium persulfate (KPS) at either 50° C. or 65° C.

FIG. 2 depicts data showing raw light scattering and ultra-violet absorption for two acrylamide (Am) free radical reactions; one in which O₂ was purged from the reactor by nitrogen (N₂) and a second one, also initially purged with N₂, in which air was flowed into the reactor ten minutes after the reaction started, and continued for approximately 60 min. When the O₂ flowed, the reaction stopped when the concentration of O₂ reached a threshold level, [O₂]ₜ, and the concentration of Am, [Am], remained on a finite plateau. On the conversion plateau, there was also no further increase in light scattering since no additional polymer is produced during the plateau. For free radical polymerization of acrylamide, the reaction spontaneously re-starts. The re-start occurs rather abruptly, causing the UV to continue decreasing and light scattering to increase. The re-start of the reaction occurs because the O₂ in the reactor is eliminated by a catalytic process of the Am. In this process, Am receives free radicals from the decaying initiator and transfers these to O₂ which then reacts with water or other substances and is eliminated. When the O₂ elimination brings the concentration of O₂ down to threshold [O₂]ₜ the reaction spontaneously re-starts.

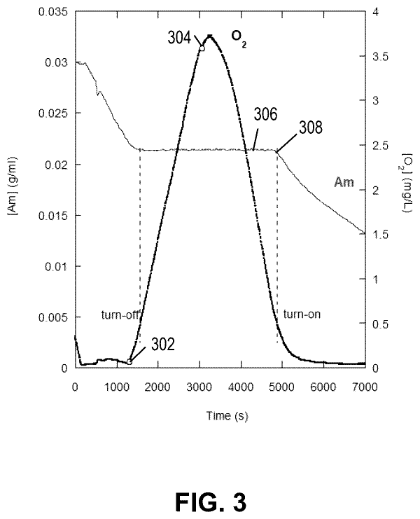

FIG. 3 shows the concentration of dissolved O₂ (DO) in the reactor, measured by the in situ RDO probe. The reaction turn-off due to increasing O₂ is seen at the beginning of the Am concentration plateau (C_{Am}). The beginning and end of the 15 sccm flow rate of the compressed air used for this reaction are indicated by discrete circles 302 and 304. As shown, when O₂ is above a threshold value [O₂]ₜ, there is a plateau 306 in the Am concentration [Am], which indicates that the reaction stops. After the O₂ is below a threshold value, the Am starts to decrease at point 308 from plateau 306.

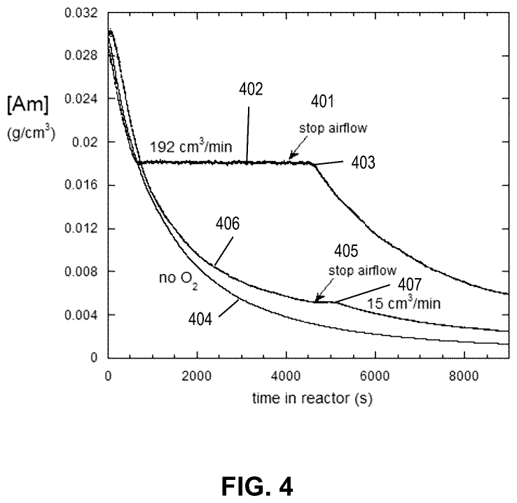

FIG. 4 shows the contrast in the short and long conversion plateaus between the two airflow rates of 192 sccm and 15 sccm, shown in FIGS. 2 and 3. The conversion is expressed in FIG. 4 as the mass concentration (g/cm³) of Am monomer in the reactor. As shown, curve 402 representing a high airflow rate of 192 sccm or 192 cm³/min has a plateau in Am concentration. The airflow stops at time 401. After the airflow stops for some time, the O₂ concentration is reduced below the threshold [O₂]ₜ by a catalytic process of the Am, the reaction spontaneously re-starts because Am concentration or [Am] starts to decrease at time 403. Without O₂, curve 404 shows that the Am concentration decreases gradually without the presence of the plateau. Curve 406 representing a low airflow rate of 15 sccm or 15 cm³/min also shows that the Am concentration starts to decrease at time 407 after some time when airflow is stopped at time 405. After the airflow is stopped for some time (e.g., about 500 seconds), the airflow is reduced below the threshold value [O₂]ₜ.

Curve 405 shows that the Am concentration at a low airflow rate of 15 sccm decreases slower than curve 404 without oxygen, which suggests that the small amount of oxygen below threshold [O₂]ₜ slows the reaction but does not stop reaction. Thus, when the O₂ elimination brings the concentration of O₂ down to threshold [O₂]ₜ the reaction spontaneously re-starts, such as at time 403 or 407.

FIGS. 2-4 show how [O₂]>[O₂]ₜ stops the reaction. For [O₂]<[O₂]ₜ, however, this low amount of oxygen [O₂] slows the reaction, but does not stop the reaction, and, additionally, the cumulative weight average molecular weight M_{w} and the instantaneous molecular weight M_{w,inst}, computed from measured M_{w} and measured polymer concentration Cₚ via Equation 4 are well below the values in the reaction with no O₂.

Hence, O₂ acts as a chain termination agent for [O₂]<[O₂]ₜ, shortening polymer chains, similar to a chain transfer agent, and O₂ can be harnessed as a reversible chain termination agent, which is a surprising discovery of the present disclosure. The small amount of O₂ below the threshold amount [O₂]ₜ can be used to reversibly control the polymer reaction. Although it has been known by those skilled in the art that a large amount of oxygen can stop the reaction, it is unknown that a small amount of oxygen under a threshold may reversibly control the reaction. Because O₂ flow can be carefully controlled, added, and eliminated as desired, O₂ can be used for fine control of molecular weight trajectories. Furthermore, O₂ can be added to a reaction at virtually any rate desired and can be quickly purged with inert gas, giving it great flexibility in application. O₂ acts as a reversible chain termination agent for [O₂]<[O₂]ₜ. Normal chemical chain transfer agents, such as sodium formate, cannot be easily removed once added to a reaction and is irreversible. Once the normal chemical chain transfer agent is added, the chain transfer agent will continue to shorten polymer chains throughout the reaction, which reduces molecular weight and decreases viscosity.

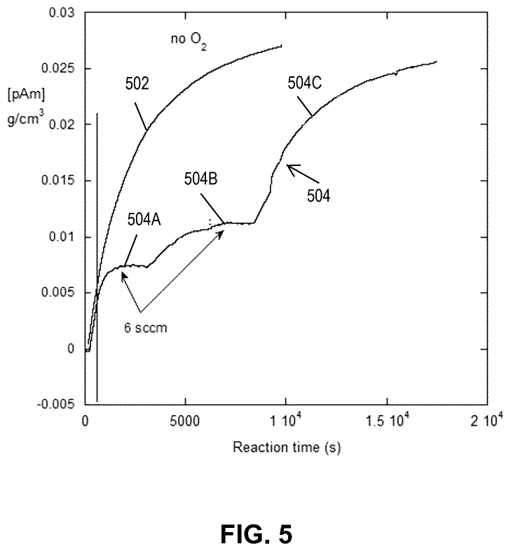

FIG. 5 shows the concentration of polyacrylamide (pAm), obtained from [Am] via mass balance, for a reaction with no O₂ (curve 502) and a second one (curve 504) with 6 sccm airflow. Again, curve 504 illustrates the effect of O₂ on the reaction compared to curve 502 without O₂. Specifically, with 6 sccm airflow, the conversion plateau 504A was reached, the reaction re-started and then 6 sccm airflow was re-started and a second conversion plateau 504B was reached. After the reaction re-started a second time, the rest of the conversion 504C resembles the normal trajectory of the reaction without O₂.

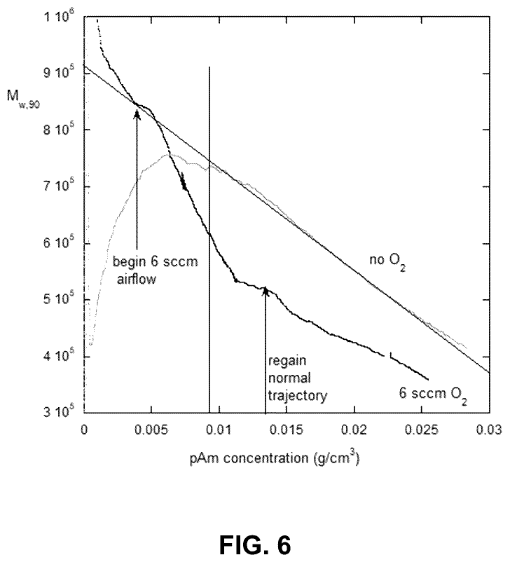

FIG. 6 compares M_{w} for the two reactions in FIG. 5. When airflow at 6 sccm begins M_{w} becomes appreciably smaller than a similar reaction with no O₂. This illustrates the chain termination and shortening feature of O₂ when below [O₂]ₜ. When the airflow is turned off, shown by the line near 0.01 g/cm³, the M_{w} trajectory regains its non-O₂ trajectory at around 0.013 g/cm³, by which moment the O₂ has been spontaneously eliminated. This illustrates the reversible nature of the chain termination effect of O₂.

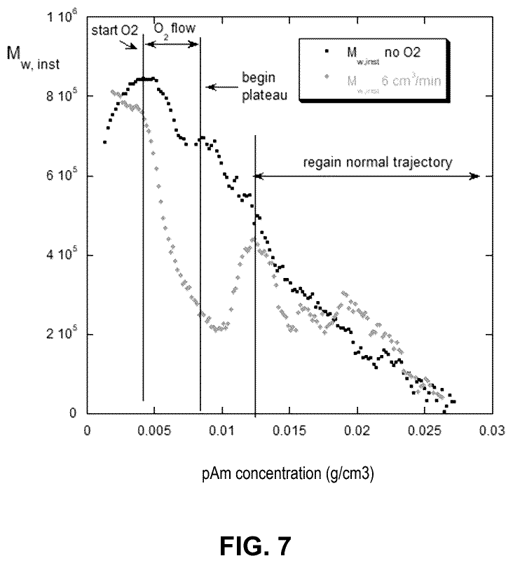

FIG. 7 shows the instantaneous weight average molecular weight M_{w,inst}, for the data in FIG. 6, computed according to Equation 4. The chains produced during the airflow period before the plateau are far smaller than the chains produced in the absence of O₂. The last part of the reaction, starting around pAm concentration of 0.012 g/cm³, brings M_{w,inst} back to close to the values for the reaction with no O₂. This further illustrates the reversible nature of O₂ as a chain termination agent. O₂ shortens chains when below [O₂]ₜ, but ceases to shorten chains once the O₂ is eliminated.

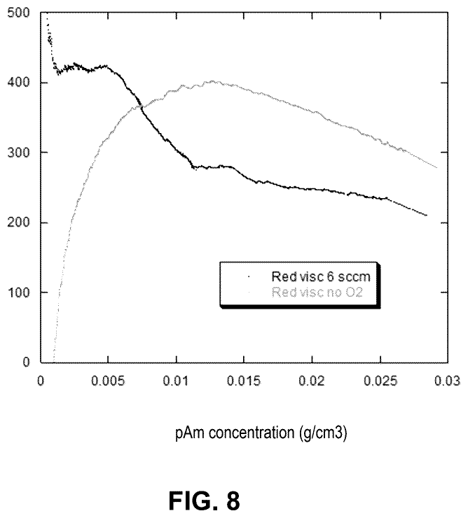

FIG. 8 shows the cumulative reduced viscosity (RV) obtained from the highly dilute sample stream. This non-optical measurement, made with a single capillary pressure transducer, provides an independent check on the chain termination and shortening effect since RV in the limit of low Cₚ is the intrinsic viscosity (IV) of polymer, which is directly related to a polymer's molecular weight and hydrodynamic volume. The behavior of cumulative RV in FIG. 8 qualitatively resembles the cumulative light scattering behavior in FIG. 5. It again shows the reversible nature of the chain termination and shortening effect of O₂.

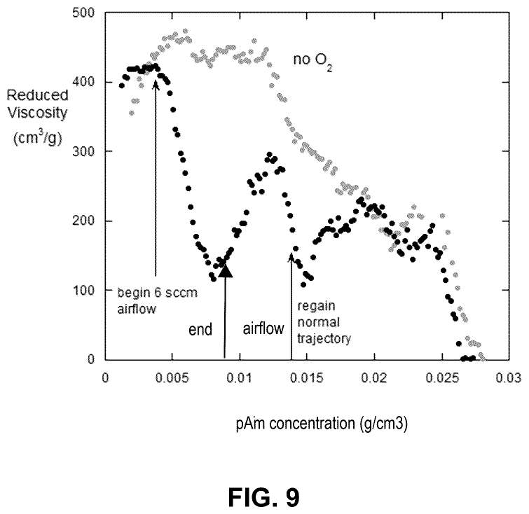

FIG. 9 shows RVᵢₙₛₜ, computed by Equation 4, substituting RV for M_{w}. RVᵢₙₛₜ with the 6 sccm airflow is below the RVᵢₙₛₜ values, mirroring the chain shortening effect found independently by light scattering.

FIGS. 7 and 9 also illustrate the reversibility of the O₂ chain termination effect. In both cases M_{w,inst} and RVᵢₙₛₜ, respectively, both increase and decrease during the reaction, and rejoin the same values as the reaction with no O₂ once O₂ is gone from the reactor. This reversible feature of O₂ as a chain termination and shortening agent is different from conventional chain transfer agents (CTA). Traditional chain transfer agents cause M_{w,inst} to be smaller than without the CTA and cannot normally be reversed unless the CTA is somehow removed or destroyed. In the present disclosure, O₂ can be carefully controlled to bring M_{w,inst} both up and down.

### EXAMPLES

The following examples are for illustration purposes only. It will be apparent to those skilled in the art that many modifications, both to materials and methods, may be practiced without departing from the scope of the disclosure.

### Example 1

The following non-limiting example of automatic molecular weight control with variable O₂ is an illustration of how the controlled flow of O₂ can modulate M_{w,inst} by the control algorithm 106. A desired trajectory for M_{w,inst} can be established versus either time or polymer concentration and this will determine the final desired MWD. The continuous monitoring of M_{w} yields its derivative quantity M_{w,inst}, available by ACOMP system 112, for example. A typical reaction lasts several hours. A control interval Δt is chosen, e.g., 60 seconds and the current value of M_{w,inst}(t), at time t during the reaction, is compared to the value at the end of the control interval, M_{w,inst}(t+Δt) and the difference is then determined by Equation 6A as follows:

$$Δ {M}_{w , inst} ( t + Δ t ) = {M}_{w , inst} ( t + Δ t ) - {M}_{w , inst} ( t ) . \qquad ( Equation 6 A )$$

The difference ΔX_{w,inst}(t+Δt) can also be expressed in terms of X_{w,inst} by Equation 6B as follows:

$$Δ {X}_{w , inst} ( t + Δ t ) = {X}_{w , inst} ( t + Δ t ) - X ( t ) . \qquad ( Equation 6 B )$$

where X represents any variable, such as viscosity, composition, or branching, among others.

A means of determining the amount of O₂ flow, flow rate Q (in sccm or other convenient units) is to make a calibration chart of the effect of Q on M_{w,inst} at any monomer concentration [Am]. First, Equation 1 is re-written as Equations 7A and 7B as follows:

$${M}_{w , inst} = d \frac{{k}_{p}}{{k}_{t} [ R ] Y + {k}_{3}^{′} Q} [ M ] \qquad ( Equation 7 A )$$

$${X}_{w , inst} = d \frac{{k}_{p}}{{k}_{t} [ R ] Y + {k}_{3}^{′} Q} [ M ] \qquad ( Equation 7 B )$$

where the O₂ flow rate Q, replaces [CTA] in Equation 1 and k₃′ has the inverse units of the flow rate Q. (M_{w,inst}=X_{w,inst}×m, where m is the monomer molar mass (g/mol)).

For a given type of reaction M_{w,inst} VS Q is made for some or all values of [M], by running the reaction at several flow rates Q under fixed, desired conditions (temperature, initiator type, and concentration). The slope of X_{w,inst} with respect to flow rate Q gives the incremental relationship between X_{w,inst} and Q from Equation 8 as follows:

$$slope = \frac{{dM}_{w , inst}}{dQ} = - \frac{{M}_{w , inst} {k}_{3}^{′} m}{{k}_{t} [ R ] Y + {k}_{3}^{′} Q} [ M ] \qquad ( Equation 8 )$$

This slope is empirical, determined by running a similar reaction at various flow rate Q values. Then, the change in the flow rate ΔQ(t) to set at the beginning of the control interval, to achieve ΔM_{w,inst}(t+Δt) from Equation 6A is

$$Δ Q ( t ) = \frac{Δ {M}_{w , inst} ( t + Δ t )}{slope ( [ M ] )} . \qquad ( Equation 9 )$$

The slopes will be negative so that decreasing M_{w,inst} means a positive ΔQ(t). The above calculation can be included in a computational algorithm in calculation module 111 of the ACOMP system 112.

While there are several ways to adjust the O₂ flow to keep on the target trajectory, one method, not limiting, is via a calibration curve.

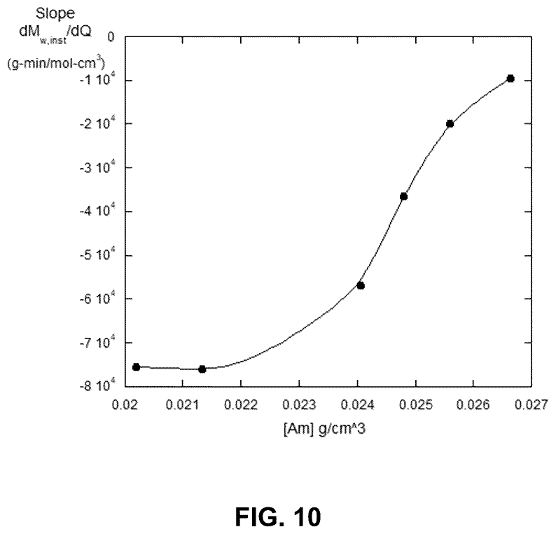

FIG. 10 shows a slope calibration curve for Am at T=50° C. with [KPS]=4.5e-4 g/cm³ where the units of the slope are g-min/mol-cm³. For example, M_{w,inst} (t)=820,000 g/mole, for a given value of flow rate Q and [Am]=0.025 g/cm³ (the polymer concentration [pAm]=[Am]₀−[Am] (t), where [Am] is measured directly by ACOMP system 112). When the target value at t+Δt is M_{w,inst} (t+Δt)=795,000, ΔM_{w,inst}(t+Δt)=−25,000. From FIG. 10 the slope is −36,200 at [Am]=0.025 g/cm³. Then, by Equation 9, the airflow rate is determined to decrease by 0.69 cm³/min.

In some variations, the slope calibration curve may vary with temperature.

In some variations, the slope calibration curve may vary with initiator type, and amount of initiator, among others.

It will be appreciated by those skilled in the art that the slope calibration curve can be obtained for any polymer characteristic X.

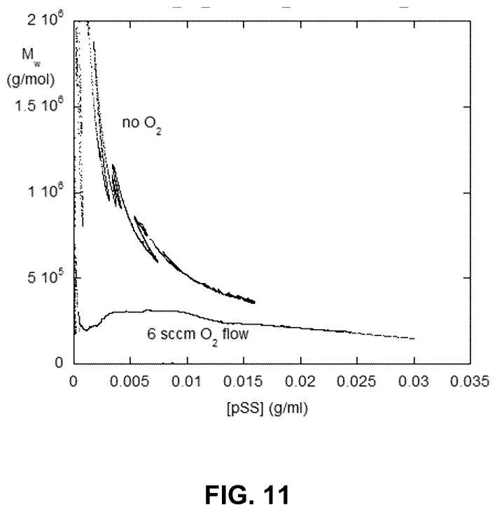

While the demonstrations above used Am, the presently disclosed methods are not limited to Am, and apply to many monomers and comonomers in both aqueous and organic phase reactions. For example, FIG. 11 shows how O₂ flow below [O₂]ₜ led to successful chain termination shortening of sodium styrene sulfonate (SS) free radical polymerization in water at 100 mM sodium chloride (NaCl) ionic strength.

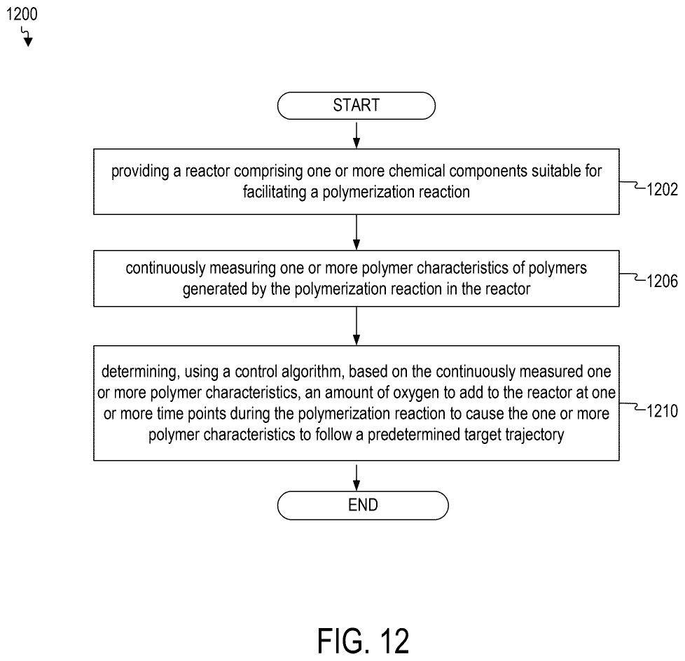

FIG. 12 is a flow chart illustrating the steps for controlling a polymerization reaction using the addition of oxygen according to an exemplary embodiment of the present disclosure. Method 1200 for controlling a polymerization reaction using the addition of oxygen includes providing a reactor comprising one or more chemical components suitable for facilitating a polymerization reaction at operation 1202.

In some variations, the polymerization reaction is selected from the group consisting of a free radical reaction, a controlled free radical reaction, a living type polymerization, a step-growth polymerization, a catalysis-assisted polymerization reaction, and any combination thereof.

Method 1200 also includes continuously measuring one or more polymer characteristics of polymers generated by the polymerization reaction in the reactor at operation 1206.

In some variations, method 1200 may also include continuous monitoring of oxygen concentration in reactor 102.

In some variations, method 1200 may also include delivering to the reactor the amount of oxygen determined by the control algorithm 106. The delivery of the oxygen to the reactor includes delivery by a controller 104 operable to automatically deliver the amount of oxygen to the reactor 102 determined by the control algorithm 106.

Method 1200 also includes determining using a control algorithm, based on the continuously measured one or more polymer characteristics, an amount of oxygen to add to the reactor at one or more time points during the polymerization reaction to cause the one or more polymer characteristics to follow a predetermined target trajectory at operation 1210.

In some variations, the one or more polymer characteristics may include weight average molecular weight.

In some variations, the one or more polymer characteristics may include instantaneous weight average molecular weight.

In some variations, the one or more polymer characteristics may include reduced viscosity of a polymer.

In some variations, the one or more polymer characteristics may include instantaneous reduced viscosity.

In some variations, the one or more polymer characteristics may include instantaneous composition of copolymers.

In some variations, method 1200 may also include determining using a control algorithm, based on the continuous measurements of one or more polymer characteristics, the amount of oxygen to add to the reactor to stop the polymerization reaction or to reduce a reaction rate by a predetermined amount.

In some variations, method 1200 may also include introducing an inert gas into the reactor to purge O₂ from the reactor 102.

In some variations, method 1200 may also include varying one or more additional control variables to the reactor 102. The one or more additional control variables are selected from the group consisting of temperature, and additions to the reaction of monomers, comonomers, initiator, catalyst, branching/cross-linking agents, and chain transfer agents.

In some variations, method 1200 may also include reversibly controlling the one or more polymer characteristics by controlling the concentration of oxygen.

In some variations, method 1200 may also include reversibly controlling M_{w,inst} by controlling the concentration of oxygen.

In some variations, method 1200 may also include decreasing M_{w,inst} by increasing the concentration of oxygen.

In some variations, method 1200 may also include increasing M_{w,inst} by decreasing the concentration of oxygen.

In some variations, method 1200 may also include spontaneously re-starting the reaction by stopping the delivery of oxygen or airflow.

In some variations, oxygen is a reversible chain termination and shortening agent.

In some variations, the concentration of oxygen is below a threshold level [O₂] to control the reaction.
Statement 1. A device comprising: a reactor in which a polymerization reaction takes place therein; a means of controlled delivery of oxygen to the reactor; and a means of continuously measuring one or more polymer characteristics of polymers generated by the polymerization reaction in the reactor.
Statement 2. The device according to statement 1, wherein the means of continuously measuring one or more polymer characteristics of polymers comprises an Automatic Continuous Online Monitoring of Polymerization reactions (ACOMP) system, wherein the ACOMP system comprises a means of continuously monitoring concentration of monomers and polymers in the reactor.
Statement 3. The device according to any one of statements 1-2, wherein the ACOMP system further comprises: a processor configured to receive data from the means of continuously monitoring concentration of monomers and polymer in the reactor; and a calculation module configured to calculate one or more polymer characteristics of polymers based on the data from the processor to generate a control algorithm.
Statement 4. The device according to any one of statements 1-3, further comprising: a tangible, non-transitory, computer-readable media having instructions encoded thereon, the instructions, when executed by a processor, are operable to: determine, using the control algorithm, based on the continuous measurements of one or more polymer characteristics, an amount of oxygen to add to the reactor at one or more time points during the polymerization reaction to cause the one or more polymer characteristics to follow a predetermined target trajectory.
Statement 5. The device according to any one of statements 1-4, wherein the reactor contains a submerged oxygen sensor for continuous monitoring concentration of oxygen.
Statement 6. The device according to any one of statements 1-5, wherein the one or more polymer characteristics comprise weight average molecular weight.
Statement 7. The device according to any one of statements 1-5, wherein the one or more polymer characteristics comprise instantaneous weight average molecular weight.
Statement 8. The device according to any one of statements 1-5, wherein the one or more polymer characteristics comprise reduced viscosity of a polymer.
Statement 9. The device according to any one of statements 1-5, wherein the one or more polymer characteristics comprise instantaneous reduced viscosity.
Statement 10. The device according to any one of statements 1-5, wherein the one or more polymer characteristics comprise instantaneous composition of copolymers.
Statement 11. The device according to any one of statements 1-10, wherein the oxygen is delivered to the reactor in form of a gas.
Statement 12. The device according to any one of statements 1-11, wherein the means of controlled delivery of oxygen to the reactor comprises a controller operable to automatically deliver an amount of oxygen to the reactor determined by the control algorithm.
Statement 13. The device according to any one of statements 1-12, further comprising: a tangible, non-transitory, computer-readable media having instructions encoded thereon, the instructions, when executed by a processor, are operable to: determine, using the control algorithm, based on the continuous measurements of one or more polymer characteristics, the amount of oxygen to add to the reactor to stop the polymerization reaction or to reduce a reaction rate.
Statement 14. The device according to any one of statements 1-13, wherein the polymerization reaction is selected from the group consisting of a free radical reaction, a controlled free radical reaction, a living type polymerization, a step-growth polymerization, a catalysis-assisted polymerization reaction, and any combination thereof.
Statement 15. The device according to any one of statements 1-14, wherein the reactor comprises a means of introducing an inert gas to purge O₂ from the reactor.
Statement 16. The device according to any one of statements 1-15, further comprising: a means of controlled delivery of one or more additional control variables to the reactor.
Statement 17. The device according to statement 16, wherein the one or more additional control variables are selected from the group consisting of temperature, additions to the reaction of monomers, comonomers, initiator, catalyst, branching/cross-linking agents, and chain transfer agents.
Statement 18. The device according to any one of statements 1-17, wherein the oxygen is a reversible chain termination and shortening agent.
Statement 19. The device according to any one of statements 1-18, wherein the concentration of oxygen is below a threshold level to control the reaction.
Statement 20. A method for controlling a polymerization reaction by varying oxygen, the method comprising: providing a reactor comprising one or more chemical components suitable for facilitating a polymerization reaction; continuously measuring one or more polymer characteristics of polymers generated by the polymerization reaction in the reactor; and determining, using a control algorithm, based on the continuously measured one or more polymer characteristics, an amount of oxygen to add to the reactor at one or more time points during the polymerization reaction to cause the one or more polymer characteristics to follow a predetermined target trajectory.
Clause 21. The method according to Statement 20 further comprising: delivering to the reactor an amount of oxygen determined by the control algorithm.
Clause 22. The method according to any one of Statements 20-21, further comprising: continuously monitoring concentration of oxygen in the reactor.
Clause 23. The method according to any one of Statements 20-22, wherein the one or more polymer characteristics comprise weight average molecular weight.
Clause 24. The method according to any one of Statements 20-22, wherein the one or more polymer characteristics comprise instantaneous weight average molecular weight.
Clause 25. The method according to any one of Statements 20-22, wherein the one or more polymer characteristics comprise reduced viscosity of a polymer.
Clause 26. The method according to any one of Statements 20-22, wherein the one or more polymer characteristics comprise instantaneous reduced viscosity.
Clause 27. The method according to any one of Statements 20-22, wherein the one or more polymer characteristics comprise instantaneous composition of copolymers.
Clause 28. The method according to any one of Statements 20-27, wherein the oxygen is delivered to the reactor in form of a gas.
Clause 29. The method according to any one of statements 20-28, wherein delivery of the oxygen to the reactor comprises delivery by a controller operable to automatically deliver the amount of oxygen to the reactor determined by the control algorithm.
Statement 30. The method according to any one of statements 20-29, further comprising: determining using a control algorithm, based on the continuous measurements of one or more polymer characteristics, the amount of oxygen to add to the reactor to stop the polymerization reaction or to reduce a reaction rate by a predetermined amount.
Statement 31. The method according to any one of statements 20-30, wherein the polymerization reaction is selected from the group consisting of a free radical reaction, a controlled free radical reaction, a living type polymerization, a step-growth polymerization, a catalysis-assisted polymerization reaction, and any combination thereof.
Statement 32. The method according to any one of statements 20-31, further comprising: introducing an inert gas into the reactor to purge O₂ from the reactor.
Statement 33. The method according to any one of statements 20-32, further comprising: varying one or more additional control variables to the reactor.
Statement 34. The method according to statement 33, wherein the one or more additional control variables is selected from the group consisting of temperature, and additions to the reaction of monomers, comonomers, initiator, catalyst, branching/cross-linking agents, and chain transfer agents.
Statement 35. The method according to any one of statements 20-34, further comprising reversibly controlling the one or more polymer characteristics by controlling the concentration of oxygen.
Statement 36. The method according to any one of statements 20-35, further comprising reversibly controlling M_{w,inst} by controlling the concentration of oxygen.
Statement 37. The method according to any one of statements 20-36, further comprising decreasing M_{w,inst} by increasing the concentration of oxygen.
Statement 38. The method according to any one of statements 20-37, further comprising increasing M_{w,inst} by decreasing the concentration of oxygen.
Statement 39. The method according to any one of statements 20-38, further comprising spontaneously re-starting the reaction by stopping the delivery of oxygen or airflow.
Statement 40. The method according to any one of statements 20-39, wherein the concentration of oxygen is below a threshold level to control the reaction.
Statement 41. The method according to any one of statements 20-40, wherein the oxygen is a reversible chain termination and shortening agent.

Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the invention. Accordingly, the above description should not be taken as limiting the scope of the invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the method and system, which, as a matter of language, might be said to fall therebetween.

1. A device comprising:
a reactor in which a polymerization reaction takes place therein;
a means of controlled delivery of oxygen to the reactor; and
a means of continuously measuring one or more polymer characteristics of polymers generated by the polymerization reaction in the reactor.

2. The device according to claim 1, wherein the means of continuously measuring one or more polymer characteristics of polymers comprises an Automatic Continuous Online Monitoring of Polymerization reactions (ACOMP) system, wherein the ACOMP system comprises
a means of continuously monitoring concentration of monomers and polymers in the reactor.

3. The device according to claim 1, wherein the ACOMP system further comprises:
a processor configured to receive data from the means of continuously monitoring concentration of monomers and polymer in the reactor; and
a calculation module configured to calculate one or more polymer characteristics of polymers based on the data from the processor to generate a control algorithm.

4. The device according to claim 1, further comprising:
a tangible, non-transitory, computer-readable media having instructions encoded thereon, the instructions, when executed by a processor, are operable to:
determine, using the control algorithm, based on the continuous measurements of one or more polymer characteristics, an amount of oxygen to add to the reactor at one or more time points during the polymerization reaction to cause the one or more polymer characteristics to follow a predetermined target trajectory.

5. The device according to claim 1, wherein the reactor contains a submerged oxygen sensor for continuous monitoring concentration of oxygen.

6. The device according to claim 1, wherein the one or more polymer characteristics comprise weight average molecular weight.

7. The device according to claim 1, wherein the one or more polymer characteristics comprise instantaneous weight average molecular weight.

8. The device according to claim 1, wherein the one or more polymer characteristics comprise reduced viscosity of a polymer.

9. The device according to claim 1, wherein the one or more polymer characteristics comprise instantaneous reduced viscosity.

10. The device according to claim 1, wherein the one or more polymer characteristics comprise instantaneous composition of copolymers.

11. The device according to claim 1, wherein the oxygen is delivered to the reactor in form of a gas.

12. The device according to claim 1, wherein the means of controlled delivery of oxygen to the reactor comprises a controller operable to automatically deliver an amount of oxygen to the reactor determined by the control algorithm.

13. The device according to claim 1, further comprising:
a tangible, non-transitory, computer-readable media having instructions encoded thereon, the instructions, when executed by a processor, are operable to:
determine, using the control algorithm, based on the continuous measurements of one or more polymer characteristics, the amount of oxygen to add to the reactor to stop the polymerization reaction or to reduce a reaction rate.

14. The device according to claim 1, wherein the polymerization reaction is selected from the group consisting of a free radical reaction, a controlled free radical reaction, a living type polymerization, a step-growth polymerization, a catalysis-assisted polymerization reaction, and any combination thereof.

15. The device according to claim 1, wherein the reactor comprises a means of introducing an inert gas to purge O₂ from the reactor.

16. The device according to claim 1, further comprising: a means of controlled delivery of one or more additional control variables to the reactor.

17. The device according to claim 16, wherein the one or more additional control variables are selected from the group consisting of temperature, additions to the reaction of monomers, comonomers, initiator, catalyst, branching/cross-linking agents, and chain transfer agents.

18. The device according to claim 1, wherein the oxygen is a reversible chain termination and shortening agent.

19. The device according to claim 1, wherein the concentration of oxygen is below a threshold level [O₂] to control the reaction.

20. A method for controlling a polymerization reaction by varying oxygen, the method comprising:
providing a reactor comprising one or more chemical components suitable for facilitating a polymerization reaction;
continuously measuring one or more polymer characteristics of polymers generated by the polymerization reaction in the reactor; and
determining, using a control algorithm, based on the continuously measured one or more polymer characteristics, an amount of oxygen to add to the reactor at one or more time points during the polymerization reaction to cause the one or more polymer characteristics to follow a predetermined target trajectory.

21-41. (canceled)
